(19) United States
(12) Patent Application Publication
(10) Pub. No.: US 2023/0116753 A1
(43) Pub. Date: Apr. 13, 2023

(54) COLLISION PROTECTION FOR A MICROSCOPE

(71) Applicant: Carl Zeiss Microscopy GmbH, Jena (DE)

(72) Inventors: Ingo FAHLBUSCH, Goettingen (DE); Martin MUELLER, Jena (DE); Johannes KNOBLICH, Jena (DE)

(21) Appl. No.: 17/938,123

(22) Filed: Oct. 5, 2022

(30) Foreign Application Priority Data
Oct. 7, 2021 (DE) 10 2021 126 096.5

(51) Int. Cl. G02B 21/26; G02B 21/24

(52) U.S. Cl. CPC G02B 21/26; G02B 21/248

(57) ABSTRACT

An apparatus for mounting an objective to a microscope structural member, and a method for operating a microscope. The apparatus for mounting an objective to a microscope structural member includes a receptacle, which is mounted or mountable to the microscope structural member, a slide-in part, which is mounted or mountable to the objective and is insertable into the receptacle where it can be brought into a locked position in which there is play between the slide-in part and the receptacle, and a tensioning unit, which, in the locked position, braces the slide-in part and the receptacle against each other in order to eliminate the play. The apparatus furthermore includes a first collision detection device, which has at least one first displacement sensor for detecting a displacement of the slide-in part and/or of the objective, in each case relative to the receptacle.

### PRIORITY CLAIM

The present application claims priority to German Patent Application No. 10 2021 126 096.5, filed on Oct. 7, 2021, which said application is incorporated by reference in its entirety herein.

### FIELD OF THE INVENTION

The invention relates to a collision protecting apparatus for mounting an objective, a microscope equipped with said apparatus, and a method for operating said microscope.

### BACKGROUND OF THE INVENTION

During microscopy, there is a risk that the objective collides with a sample when the objective is moved for shifting a field of view or for focusing. Several approaches have been developed to avoid such collision which may damage the microscope objection or the sample or both.

DD 274687 A1 describes a way of protecting the objective by mounting it resiliently and axially displaceable in an objective holding tube.

DE 10 2017 120 651 B3 discloses a microscope having a stand, on which a microscope stage for carrying a sample and an objective are arranged, and a positioning system for adjusting a distance between the microscope stage and the objective and/or for adjusting an xy position of the microscope stage. The microscope has a force or pressure sensor, and therefore a transmission of force from the microscope stage to the objective or vice versa, i.e. in the z direction, is identified.

DE 10 2016 125 691 B4 provides for a holder with thrust elements for sample carriers and a method for controlling a microscope. Pressure sensors accommodated in the thrust elements can be used to evaluate whether forces occur in addition to the normal object carrier clamping force.

DE 10 2013 006 997 A1 describes an objective holder with sample and jamming protection which simultaneously has the function of collision protection. In the event of a collision, the optical system is displaced in relation to the objective housing counter to a spring force until an integrated micro electrical switch is switched over.

DE 10 2018 205 894 A1 discloses an objective changer in which an objective is drawn out of a magazine into the optical beam path and fixedly retained in the process.

DE 10 2010 001 604 A1 describes mounting of optical microscope components preferably to a microscope stand. The interface (bayonet) of the mount is secured with a fixing screw.

### SUMMARY OF THE INVENTION

It is an object of the invention to improve collision protection for an objective which is universal, i.e. not restricted to certain samples holders or the like.

The invention is defined in the independent claims; the dependent claims relate to preferred developments.

Embodiments provide an apparatus for mounting an objective to a microscope structural member, preferably to a microscope stand or to a further microscope component, with the option of passing through data signals and/or the electrical supply power, wherein the apparatus comprises a receptacle, which is mounted or mountable to the microscope structural member, and a (preferably annular) slide-in part, which is mounted or mountable to the objective. The receptacle optionally has a base ring and a holding collar provided on the base ring and having a lateral opening for receiving the slide-in part.

In embodiments, the apparatus is an interface for mounting an objective to a microscope structural member, preferably to a microscope stand or to a further microscope component.

The slide-in part slides into the receptacle. Once inserted into the receptacle, the slide-in part can be brought into a locked position in which the slide-in part cannot be removed from the receptacle along any movement following a straight path. However, there still is play possible between the slide-in part and the receptacle. In the locked position, a tensioning unit braces the slide-in part with respect to the receptacle in the locked position to eliminate the play.

The tensioning unit places slide-in part and receptacle against one another without play, and nevertheless the slide-in part can still move in the receptacle within the scope of the play. A first collision detection device comprises at least one first displacement sensor for detecting a relative displacement between the slide-in part and/or of the objective on the one hand and the receptacle on the other hand. Thus, the first displacement sensor senses a relative displacement which is usually a relative movement and outputs a respective first displacement sensor signal indicating the relative displacement. The first displacement sensor can derive this signal from a position detection, i.e. from a non-relative measurement.

By means of this principle, a collision is detected on the basis of a relative displacement between receptacle and slide-in part. A precise and at the same time universal collision detection is therefore achieved, in particular because the sample is not referred to or utilized in such detection.

Particularly advantageously, the first displacement sensor detects the relative displacement on the basis of a change in a tension state of the tensioning unit since a relative displacement of the slide-in part within the scope of the play as a rule changes, usually increases, the tension in the tensioning unit. For this purpose, the tensioning unit particularly preferably comprises a pressure spring and a thrust element which is tensioned by the pressure spring to lie against the slide-in part, and the first displacement sensor senses a movement of the thrust element and/or a pressure exerted by the thrust element.

The mounting of the objective can be configured as a bayonet interface, wherein the receptacle forms the bayonet ring or is integrated therein, and the slide-in part forms the bayonet flange or is integrated therein. The receptacle can be preassembled on the second part, e.g. on the stand of a microscope, or can be slideable as a unit into the second part, e.g. an objective revolver, of the microscope.

In the locked position, a gap can be provided at least in regions in the x and/or y direction (i.e. transversely with respect to the optical axis of the objective) between the slide-in part and the receptacle. In the locked position, the slide-in part and the receptacle can lie against each other at least in regions in the x and/or y direction. In the event of lateral contact or collision of the objective, i.e. in the x and/or y direction, the slide-in part moves at least sideways in the receptacle, e.g. in the form of tilting. The slide-in part presses against the receptacle, e.g. a holding collar, in the process. The objective is displaced to the side and/or tilted with respect to its optical axis. However, it remains fixedly connected to the slide-in part, e.g. via a thread. The displacement of the slide-in part in the receptacle caused by the contact or collision is detected via the at least one first displacement sensor. Therefore, forces acting laterally on the objective, i.e. forces in the x and/or y direction, can be identified. The same also applies to z forces if receptacle and slide-in part lie against each other via oblique surfaces and an axial force within the scope of the play likewise leads to a lateral shifting of the slide-in part relative to the receptacle.

The first displacement sensor preferably detects a lateral displacement, i.e. a movement which runs transverse to an optical axis of the objective, and/or an axial relative displacement, i.e. a movement which runs along the optical axis.

For the tensioning unit, at least one first spring element can be provided which, in the locked position, is tensioned between the receptacle and the slide-in part. In the locked position there is therefore, as already explained, a spring travel within the scope of the play. Once the slide-in part has moved in the receptacle in the event of a collision and once the reason for the collision has been eliminated, the tensioning unit pushes the slide-in part back again into its standard position within the receptacle.

In the event of a collision, the play and the tensioning unit therefore provide a reaction distance which allows to shut down, to brake or to switch off drives which have carried out the collision travel without damage or permanent deformation immediately occurring. These measures make it possible to avoid a hard crash of the objective since tensioning unit and play permit a deflection to a certain extent. This is true both axially (pure axial landing the objective) and also laterally (inclining the objective).

The first displacement sensor can be a sensor of the following type: a position sensor provided in or on the receptacle and/or the slide-in part, a position sensor including a magnetic transducer, a pressure sensor, and an inclination sensor provided in or on the receptacle, the slide-in part and/or the objective, or a combination of those types. The inclination sensor can be selected from a gyroscope, an angle-sensitive sensor sensing on basis of a magnetic field, a strain sensor, a pressure sensor, and a piezo film sensor. Furthermore, the pressure sensor can be selected from a force-measuring resistor and a piezo film sensor. The first displacement sensor therefore realizes an active collision detection. The first displacement sensor optionally also detect whether a slide-in part and/or a first part with collision protection is actually present on the receptacle, e.g. by sensing the state of the tensioning unit.

In embodiments, at least one position sensor can be provided in the receptacle, e.g. at the holding collar, wherein the position sensor senses a sensed element which is provided on the slide-in part and juxtaposed to the position sensor when the slide-in part is in the locked position. Alternatively, the position sensor can be arranged on the slide-in part and the sensed element can be arranged in the receptacle.

In embodiments, the first displacement sensor not only to detects a change in position of the slide-in part in the receptacle and thereby a collision, but also detects whether a particular slide-in part which is provided with a particular objective is in place, i.e. whether a particular objective is in use. Furthermore, the first displacement sensor can optionally detect whether the slide-in part was arranged in the locked position.

The tensioning unit can comprise, as spring element, a pressure spring, and a thrust element engaging the pressure spring, wherein the thrust element comprises at least one element selected from a thrust piece, a ball, a ball bearing, a spring sheet, a lever, an extension arm of a lever, and a pressure sensor of the first displacement sensor. The spring element can furthermore comprise the first displacement sensor or can be configured as the first displacement sensor, for example in form of a piezo film sensor.

The tensioning unit can be configured to exert a spring force upon both, the slide-in part and a pressure sensor, which is arranged in or at the receptacle and is provided as the first displacement sensor, wherein the spring force acting on the pressure sensor depends on the shift of the slide-in part within the range of the play. Therefore, an increase in pressure indicates the relative displacement. The tensioning unit is therefore also referred to below in short as “spring element”.

The spring element can be provided, for example, on a device of the holding collar positioning the slide-in part. The device of the holding collar positioning the slide-in part can comprise a protrusion of the holding collar, against which, in the locked position, a positioning stop, e.g. a pin, of the slide-in part rests. In one example, the slide-in part is brought into the locked position by rotation in the receptacle, the rotation being stopped by a laterally arranged pin of the slide-in part with the pin engaging a lateral protrusion of the holding collar which delimits the lateral opening in form of a stop. Since the spring element is supported by the protrusion of the holding collar, a collision not only presses the slide-in part against the holding collar, but also presses the positioning stop against the protrusion. Thereby the spring element and, if provided on the spring element, the first displacement sensor become effective.

In embodiments, the slide-in part is ring shaped comprising an outer side featuring conical holding protrusions. The receptacle has a holding collar comprising a lateral opening and an inwardly facing cone tapering away from a base ring. The slide-in part can be insertable through the lateral opening into a pre-locked position in which the ring openings overlap, and the slide-in part and the receptacle can be brought, by mutual rotation, from the pre-locked position into a locked position in which the conical holding protrusions of the slide-in part are held against the cone of the holding collar and bias the slide-in part against the base ring. At least three holding protrusions can be provided for that.

The lower side of the slide-in part facing the base ring, or the upper side of the base ring facing the slide-in part, can comprise plane bearing elements. At least two plane elements can be provided. The slide-in part can comprise magnets and the receptacle can comprise counter magnets which are arranged complementary to the magnets in the locked position. A magnetic attraction can be applied to the slide-in part, thus, and the slide-in part is drawn into the locking position.

The holding protrusions and/or the plane bearing elements and/or the magnets/counter magnets can form defined contact points which unambiguously and reproducibly define the position of the slide-in part in the receptacle in the locked position.

According to one embodiment, an objective is mounted to the slide-in part, and a second collision detection device is provided in a sleeve of the objective. The second collision detection device can comprise a safety element, which surrounds at least a front lens of the objective, and a second displacement sensor. The safety element can be a housing element. Further it can be arranged resiliently and axially movably in the objective sleeve by means of at least one second spring element acting in the direction of the front lens of the objective, and the second displacement sensor can detect movement between the front lens of the objective and the safety element. For signal generation by the second displacement sensor, it is possible to arrange a thrust element which is adjustable in direction to the front lens of the objective and being mechanically linked to the second displacement sensor at a point of contact (triggering point). For example, the objective sleeve can be part of a lens mount. With this embodiment, a collision can be detected along the z direction and differentiated from a lateral displacement. It is therefore possible to differentiate collisions from different directions. The first displacement sensor and the second displacement sensor permit active identification of a collision type.

Because of the tensioning unit, the slide-in part repositions automatically at the optical axis once the collision is eliminated. The objective also springs back in the z direction into its required position. The spring force of the first spring element and/or the spring force of the second spring element can be adjustable in all of the embodiments, for example in each case by an adjusting screw.

In embodiments, the second part can be a microscope stand, an objective revolver, an objective changing device or an objective delivery device of a microscope. Furthermore, the first part can be an objective or an objective device of a microscope. The receptacle or the displacement sensors thereof and/or spring elements and/or magnets can be integrated in an objective revolver.

The apparatus for mounting an objective can be configured to pass through data signals and/or the electrical supply power. The lower side of the slide-in part facing the base ring can comprise at least one electrical contact element and the upper side of the base ring oriented toward the lower side of the slide-in part can comprise a matching electrical mating contact element in order to produce an electrical power connection and/or data connection between slide-in part and receptacle.

Furthermore, a first drive can be provided for moving the objective in an x direction and/or y direction and/or a second drive can be provided for moving the objective in the z direction. For example, the first drive can be provided at the second part, e.g. a microscope stand, and the second drive can be arranged at the objective, e.g. an objective holder, or at the second part. Furthermore, a control device can be provided having data connection, e.g. via a control bus, via control lines and/or wirelessly, to the receptacle, the slide-in part, the first displacement sensor, the second displacement sensor, the first drive and/or the second drive device. In embodiments, the control device comprises a storage device and a processor.

In embodiments, a microscope comprises the mentioned interface for collision-protecting mounting of the objective according to one of the preceding embodiments, a sample receiving volume for receiving a sample, a drive for moving the objective, which is mounted to the receptacle, and a control device which is connected to the drive and to the first displacement sensor and is configured to stop or revers the drive when the displacement sensor indicates a collision.

The control device can be configured to record a movement direction of the drive and, after the stopping, to reverse the drive counter to the previous movement direction in order to eliminate a collision state.

The objective can additionally comprise said objective sleeve in which the second collision detection device is arranged, and the second collision detection device can comprise the safety element, which encompasses the optical elements of the objective, and the second displacement sensor, wherein the safety element is arranged resiliently and axially movably in the objective sleeve by means of at least one second spring element acting in the direction of a front lens of the objective, and the second displacement sensor is arranged between the front lens of the objective and the safety element.

In embodiments, a method for operating such microscope comprises the steps of: moving the objective relative to the sample receiving volume, monitoring the relative displacement signal at least of the first displacement sensor and stopping the movement of the objective when the relative displacement signal indicates a relative displacement. Determining a collision direction and/or an absolute value of a distance covered during a collision and/or a position from which the collision has taken place, and further moving the objective, after the stopping, in a direction which depends on the result of the determination, are options. In addition, the following can be undertaken: recording a movement direction of the objective during the movement step, and further moving the objective counter to the movement direction after the stopping. Possibilities here include: stopping the movement of the objective by counter current braking, or ramping down, by switching off the drive by the control device in the event of a collision, and/or storing positions of the objective in which a displacement was detected and subsequently moving the objective with said stored positions being excluded, and/or defining spatial areas of the objective and assigning a collision probability to each area and moving the objective at an increased or reduced speed depending on the position of the objective in the spatial areas and therefore operating the microscope based on the collision probability.

A further embodiment relates to a method for operating a microscope having said mounting interface, wherein the receptacle is mounted to the second part and the slide-in part is mounted to the objective. The first displacement sensor of the first collision detection device detects the relative displacement of the slide-in part and/or a relative displacement, in particular in form of inclining, of the objective—in each case relative to the receptacle.

In a modification of the method, the objective is mounted to the slide-in part and the second collision detection device with the safety element is provided in the sleeve of the objective; the method being able to include the step of: detecting a movement of the safety element in the objective sleeve by means of the second displacement sensor of the second collision detection device.

The method can comprise at least one step, selected from
triggering a signal of the first and/or the second displacement sensor in the event of a collision;
conducting a signal of the first and/or the second displacement sensor to the control device in the event of a collision;
braking the first and/or the second drive, preferably with counter current braking, by the control device in the event of a collision;
stopping the first and/or the second drive, preferably by ramping down a drive current or voltage, by the control device in the event of a collision;
switching off the first and/or the second drive by the control device in the event of a collision;
storing the collision direction, the absolute value of the distance covered during the collision and/or the position from which the collision has taken place, in the control device;
storing a temporally limited and/or temporally final movement and/or adjustment of the objective carried out by the first and/or second drive in the control device and taking same into consideration in the event of a collision;
moving the objective, in particular the objective lens and/or the objective device, in anti-collision direction by means of the first drive;
moving the objective and/or adjusting the objective lens and/or the objective device in anti-collision direction by means of the second drive;
moving the objective and/or adjusting the objective and/or the objective device with collision coordinates and/or a stored position, from which a collision has taken place, being excluded;
switching on the first and/or the second displacement sensor when the first and/or second drive is activated;
identifying microscope components, which are used as the first part and/or as the second part, in the control device and/or taking same into consideration during the operation of the first and/or second drive; and
defining spatial areas in the x, y and/or z direction, in which the first and/or the second drive are/is operated at an increased or reduced speed, depending on a collision probability.

The method can further comprise at least one of the following steps: determining whether an objective is mounted by the mounting interface for collision protection to the second part; determining whether the first and/or the second drive is operating; activating the first displacement sensor and/or the second displacement sensor; determining collision coordinates; moving the objective, in particular the objective lens and/or the objective device, into a position outside the collision coordinates; deactivating the first displacement sensor and/or the second displacement sensor.

In order to be able to eliminate the reason for a collision, it is advantageous that the final traveling movements of the drive are recorded. This recording can be used after detection of a collision and a return travel for eliminating the collision state can be initiated. Furthermore, a temporally limited travel track of the individual drives can be recorded in order to initiate a return travel after collision. It is advantageous to define spatial regions in the x, y and/or z direction, through which the drive devices can shift the objective with a rapid feed displacement, and to define high risk regions in the x, y and/or z direction, in which travel may be undertaken only at a reduced speed. For example, in the vicinity of an opening in a stage of a microscope or in a possible focusing travel span of the objective. For this purpose, a workflow can be provided for the control device. Said workflow can depend on the components actually used on the microscope and is variable as a result. Furthermore, the components which are presently used can be automatically registered in the control device, as a result of which said workflow can be automatically compiled and generated. The collision protection can advantageously be activated only when the drives travel the objective in the z, x, y direction, i.e. the first and/or the second displacement sensor can be switched on only upon activation of a first and/or second drive device. An operator of the optical device can therefore exchange the objective without need to switch off the drive devices or the risk to trigger a collision eliminating return travel.

In a microscope features and/or steps of the methods disclosed herein can be controlled by a control device of the microscope which control device is configured accordingly and may comprise a processor.

One embodiment relates to a computer program product having program elements which cause the apparatus according to one of the preceding embodiments to carry out steps of the method for operating the apparatus according to one of the preceding embodiments, in particular if the program elements are loaded into a storage device of the apparatus. A further embodiment relates to a computer-readable medium, on which the computer program product according to the preceding embodiment is stored.

Further features and expediencies will become apparent from the following description of exemplary embodiments, the figures and the dependent claims. It is understood that the features mentioned above and the features still to be explained below can be used not only in the specified combinations but also in other combinations or on their own without departing from the scope of the present invention. The apparatus for mounting an objective to a microscope structural member will also be called collision protecting apparatus below.

### BRIEF DESCRIPTION OF THE DRAWINGS

The invention will be explained in even more detail below on the basis of exemplary embodiments, with reference being made to the appended drawings, which likewise disclose features essential to the invention. These exemplary embodiments are only illustrative and should not be construed as restrictive. For example, a description of an exemplary embodiment with a multiplicity of elements or components should not be construed as meaning that all of these elements or components are necessary for implementation. Rather, other exemplary embodiments can also contain alternative elements and components, fewer elements or components, or additional elements or components. Elements or components of different exemplary embodiments can be combined with one another, unless stated otherwise. Modifications and variations which are described for one of the exemplary embodiments can also be applicable to other exemplary embodiments. In order to avoid repetition, the same elements or corresponding elements in different figures are denoted by the same reference signs and are not explained multiple times. In the figures:

FIG. 1 schematically shows, as an example, a collision protecting apparatus 10 for components of an optical device;

FIGS. 2A to 2C schematically show the receptacle and the slide-in part of the collision protecting apparatus 10;

FIGS. 3A and 3B show schematic cross-sectional views of a collision protecting apparatus 100 as a further example,

FIG. 4 shows a schematic cross-sectional view of a collision protecting apparatus 200 as a further example;

FIGS. 5A and 5B schematically show enlarged cross-sectional views of the collision protecting apparatus 200;

FIGS. 6A to 6D schematically show a collision protecting apparatus 300 as a further example;

FIGS. 7A and 7B schematically show a collision protecting apparatus 400 as a further example;

FIG. 8 schematically shows an objective revolver 150 of a microscope;

FIG. 9 schematically shows a sequence diagram of an example of the method for operating the collision protecting apparatus; and

FIGS. 10A to 10C schematically show exemplary microscope systems in which the collision protecting apparatus is implemented.

### DETAILED DESCRIPTION

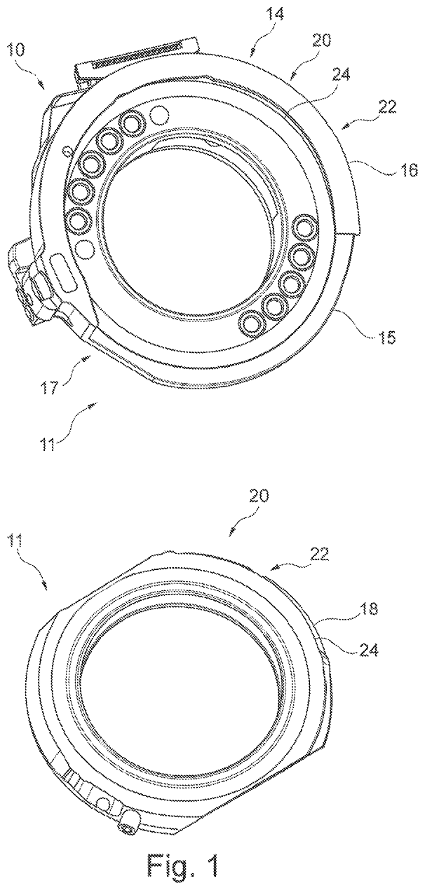

FIG. 1 schematically shows, as an example, a collision protecting apparatus 10 for components of an optical device, e.g. a microscope. The collision protecting apparatus comprises a interface device 11 for mounting an objective 12 to a second part 13, preferably to a microscope stand or a microscope component. The interface device 11 can be configured with the option of passing through data and/or the electrical supply. A receptacle 14, which is mounted or mountable to the second part 13, and an annular slide-in part 18, which is mounted or mountable to the objective 12, are provided. The receptacle 14 has a base ring 15 and a holding collar 16, which is provided on the base ring. The holding collar 16 has a lateral opening 17 through which the slide-in part 18 slides into the receptacle 14. Furthermore, a first collision detection device 20 is provided which has at least one first displacement sensor 22 for detecting at least one displacement selected from a movement of the slide-in part 18 in the receptacle 14 and a movement, in particular inclination, of the objective 12 relative to the receptacle 14.

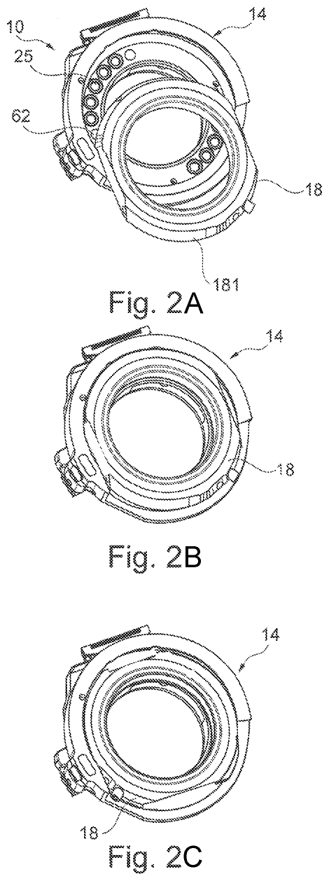

FIGS. 2A to 2C illustrate the receptacle 14 and the slide-in part 18, in different stages of connecting the receptacle and the slide-in part with each other. In FIG. 2A, the slide-in part 18 is inserted through the lateral opening 17 approximately half way into the receptacle 14. FIG. 2B illustrates the slide-in part 18 slid fully into the receptacle 14. FIG. 2C depicts the receptacle 14 and the slide-in part 18 in a locked position. The interface device 11 for mounting the objective 12 to the second part 13 can be configured as a bayonet interface, wherein the receptacle 14 acts as a bayonet ring and the slide-in part 18 as a bayonet flange.

In the embodiment depicted, the displacement sensor 22 consists of a position sensor 24. The position sensor comprises a transducer and a sensed element. The transducer is provided on the inner side of the holding collar 16, and the sensed element is provided on the slide-in part at a position that it is juxtaposed the transducer, when and the slide-in part and the holding collar 16 are in the locked position. The transducer generates a signal which depends on the distance between sensed element and transducer.

In the locked position, there would be play between the slide-in part 18 and the receptacle 14. However, a tensioning device eliminates that play by bracing the slide-in part 18 and the receptacle 14 against each other. In the event of a lateral collision between an object and the objective 12 mounted to the slide-in part 18, the slide-in part 18 is displaced in the receptacle 14 as far as the play allows. As a result, the transducer provided on the slide-in part 18 moves relative to the sensed element provided on the holding collar 16 and generates a signal showing that the slide-in part 18 was displaced out of the regular position—hence the name “position sensor”. The position sensor 24 then outputs a displacement sensor signal, e.g. to a control device of the optical device. In this way, a collision is detected.

If the slide-in part 18 is selectively provided with a particular objective, such as a certain type of objective, it can also be identified whether this particular objective is present, once the receptacle 14 and the slide-in part 18 are connected. Furthermore, it can be identified by means of the position sensor 24 whether the slide-in part 18 is arranged in the locked position.

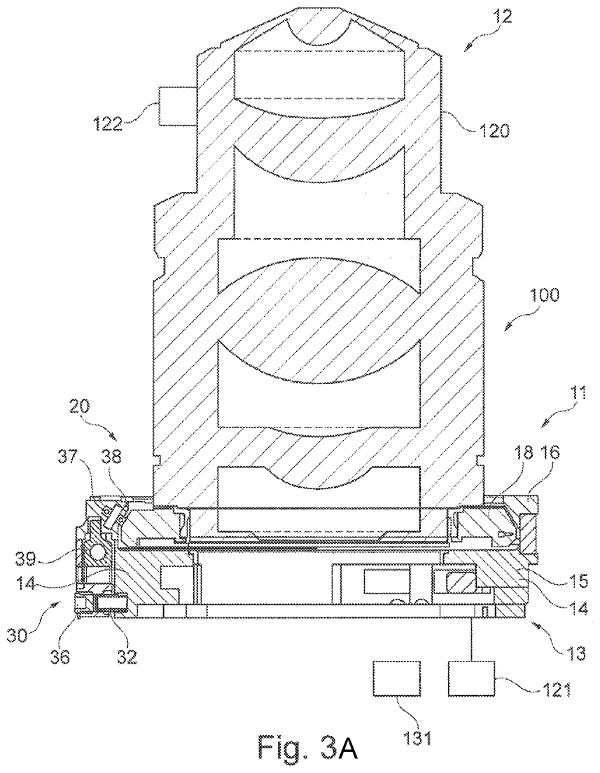

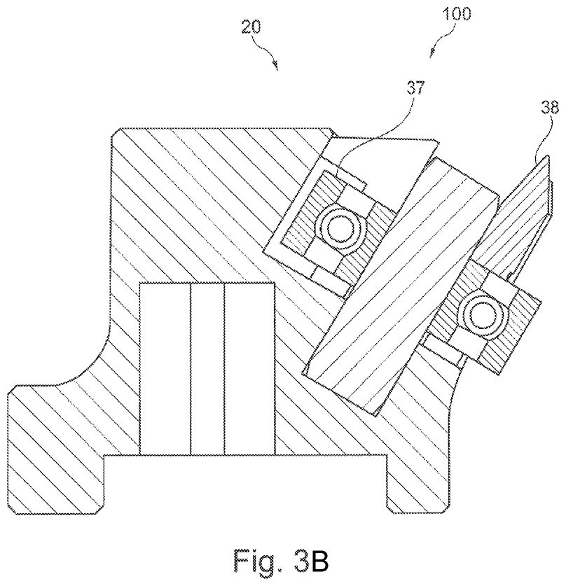

FIG. 3A shows a schematic cross-sectional view of a collision protecting apparatus 100 as a further example. The slide-in part 18 is shown in the receptacle 14 in the locked position. An objective 120 is mounted to the slide-in part 18, and the receptacle 14 is mounted to a second part 13, e.g. a microscope stand. To eliminate the play between the slide-in part 18 and the receptacle 14 in the locked position, the collision protecting apparatus 100 has at least one tensioning device 30. The tensioning device 30 is provided on the receptacle 14 and has a pressure spring 32 which is tensioned when in the locked position. The spring force of the pressure spring 32 can be adjusted with an adjusting screw 36. The pressure spring 32 acts on a lever 39 which is provided on the outer side of the receptacle 14. The lever 39 is increases the spring force of the pressure spring 32 via a lever arm to generate higher thrust. The lever 39 furthermore acts on a ball bearing 37. FIG. 3B illustrates an enlarged view of the installed ball bearing 37. The ball bearing 37 transmits the lever force to the contact point at the slide-in part 18 with little wear and without loss. In the present example, the ball bearing 37 is integrated in a thrust piece 38. Instead of the ball bearing 37, a ball with an optional spring sheet can be used. In further variants, the lever arm can be dispensed with and the pressure spring 32 acts directly on the ball bearing 37 or on a similar thrust piece. The advantage of the lever mechanism illustrated in FIG. 3A consists in that the pressure stage with the pressure spring 32 can be arranged within the second part 13, e.g. in an objective revolver, and the space above the second part 13 remains free from additional structure. The collision protecting apparatus 100 comprises the displacement sensor 22 of the collision protecting apparatus 10 (not illustrated in FIG. 3A).

When the receptacle 14 and the slide-in part 18 are connected to each other in the locked position, the tensioning device 30, i.e. the pressure spring 32 in the present example, allow for a spring travel defined by the extent of possibly play. When the slide-in part 18 has moved in the receptacle 14 due to a collision, the tensioning device 30 presses the slide-in part 18 back again into its required play-eliminating position once the collision was eliminated. In the event of a collision, the spring travel provides for a reaction distance which makes it possible to shut down, brake or switch off objective moving drives in time, before damage occurs due to a displacement exceeding the play. These measures avoid a hard crash of the objective with an external structure which collided with the objective. Advantageously, a (e.g. temporally limited) travel track of the individual drives can be recorded in a storage device in order to initiate a return travel following the prior onward path.

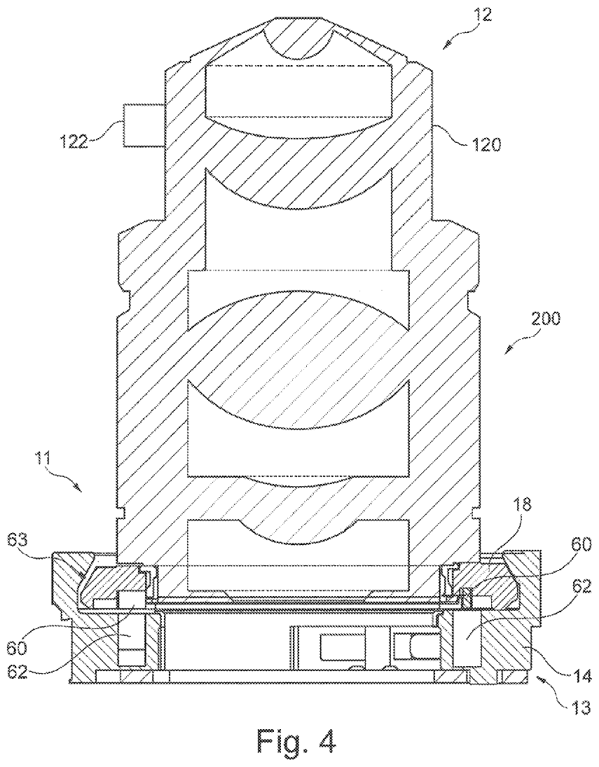

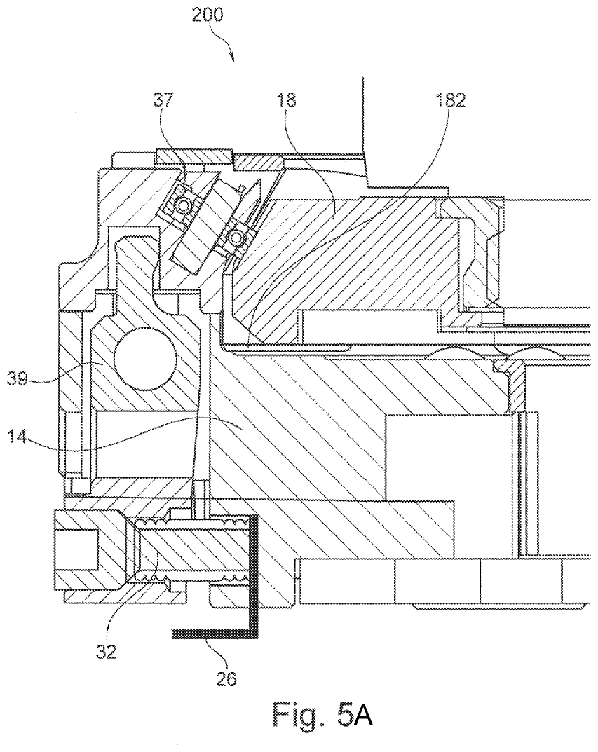

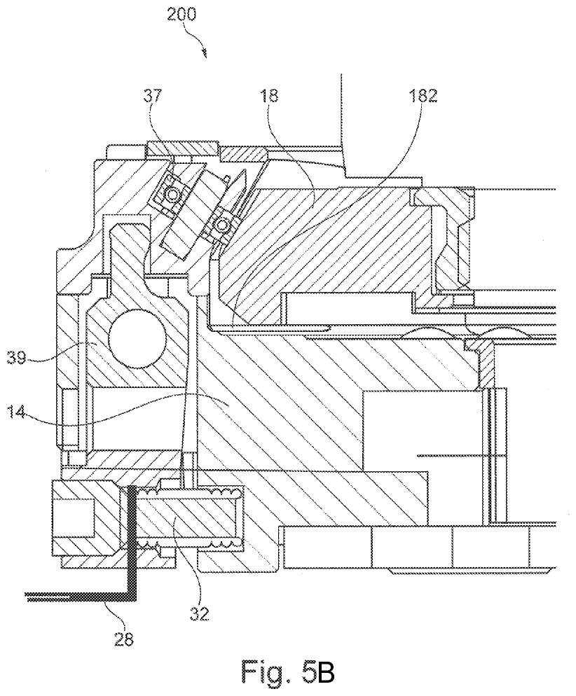

FIGS. 4, 5A and 5B schematically show a collision protecting apparatus 200 in a further embodiment. In FIG. 4, the ball bearing is not depicted in order to better show the play between the slide-in part 18 and the receptacle 14 in the locked position. It can be seen from FIG. 4 that the slide-in part 18 comprises a plurality of magnets 60 and the receptacle 14 a plurality of counter magnets 62, which magnets and counter magnets are arranged in complementary manner with respect to one another in the locked position. FIG. 4 furthermore shows a gap 63 which provides the play between the slide-in part 18 and the receptacle 14 in the locked position. The gap 63 allows movement in case of a collision in order to prevent a hard crash and a displacement distance (e.g. due to tilting of the objective) allows to stop the drives.

In FIG. 5A the collision protecting apparatus 200 differs from the collision protecting apparatus 100 in that the displacement sensor is a pressure sensor 26, e.g. a pressure film. The position sensor 24 can be dispensed with. The pressure spring 32 is supported by the pressure sensor 26. Hence, the pressure spring 32 increases pressure on the pressure sensor 26 in the event of a collision, because the pressure spring is compressed then. A collision from the x or y direction or from the x and y direction simultaneously causes the pressure sensor 26 to immediately respond since every smallest displacement of the slide-in part 18 in the receptacle 14 is detected.

FIG. 5B depicts a variant of the collision protecting apparatus 200. The displacement sensor 22 is realized by a piezo film sensor 28 engaging the pressure spring 32. The piezo film sensor 28 makes it possible to detect a movement of the slide-in part 18 in the receptacle 14 via the detection of the change in the deflection of the film sensor itself.

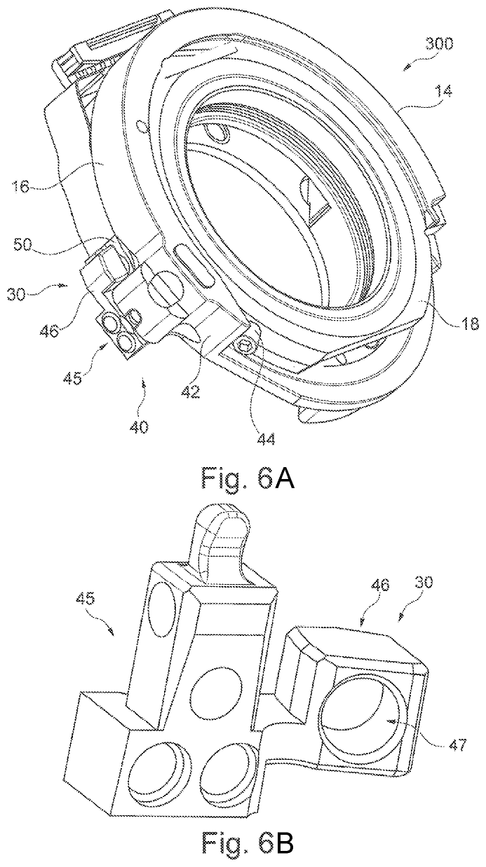

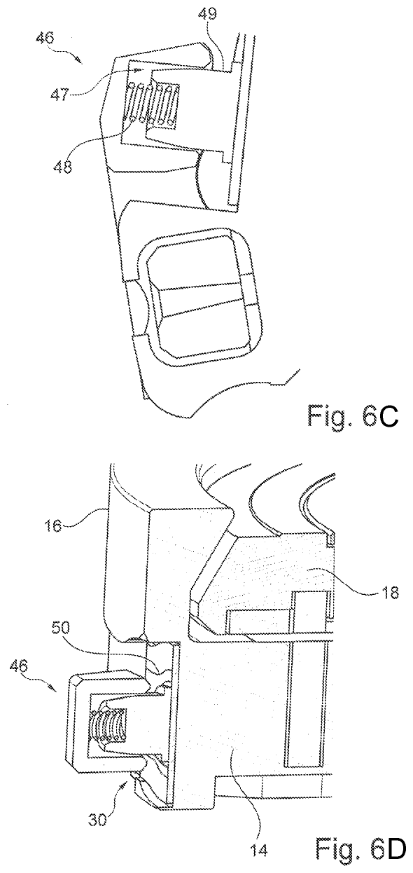

FIGS. 6A to 6D schematically show, as a further example, a collision protecting apparatus 300, with FIGS. 6C and 6D being cross-sectional views. As can be seen in FIG. 6A, the tensioning device 30 is provided on a slide-in part positioning device 40 of the holding collar 16. In the present example, the device 40 comprises a protrusion 42 on the holding collar 16, against which, in the locked position, a stop 42, in the present example a pin, of the slide-in part 18 lies. The stop 42 delimits the lateral opening 17 of the holding collar 16. In this example, the slide-in part 18, after being fully inserted into the receptacle 14, is rotated into the locked position. The rotation of the slide-in part 18 is stopped as soon as the pin 44 engages the stop 42. In the present example, the device 40 has a lever 45 and is configured as a lever mechanism which positions the slide-in part 18 in the receptacle 14. In the locked position, there is play between the slide-in part 18 and the receptacle 14.

As FIGS. 6B to 6D show, the tensioning device 30 is configured as an extension arm 46 of the lever 45, the extension arm 46 comprising a bore 47 as a blind hole. A pressure spring 48 with a thrust piece 49 is inserted into the bore 47. The thrust piece 49 presses on a force-measuring resistor 50, which realizes the displacement sensor 22 in this embodiment. The pressure spring 48 is advantageously configured in such a manner that its spring rate increases the thrust force, whereby the reaction time for determining a collision is minimized.

It is also detected whether the slide-in part 18 with an objective 12 is inserted in the receptacle 14 or not. If the objective 12 is not connected to the receptacle 14, the force-measuring resistor 50 measures a low force. If the objective 12 is provided in the receptacle, a force in a defined range is measured. When the objective 12 collides with an object laterally, an increased force is measured. Since the tensioning device 30 is provided on the stop 42 of the holding collar 16, a collision biases the positioning delimitation 44 of the slide-in part 18 against the protrusion 42, and the tensioning device 30 and the force-measuring resistor 50 can carry out their action.

Once the collision is eliminated, the lever 45 moves the objective 12 back again into the required optical working position. The advantage of this solution consists in that an objective can be checked in respect of its functioning at a manufacture site even when only preassembled with the slide-in part 16 and not yet finally mounted to an objective revolver or a another component of the optical device. The objective revolver or the other component therefore does not require any additional elements to detect a collision. This considerably simplifies the design of the objective revolver or of the other component. The signal output by the force-measuring sensor 50 can be transmitted, to the optical device, such as a microscope, or to the control device thereof via a plug connector, which is mounted on the receptacle 14, and a cable harness plugged into said plug connector.

In embodiments, the outer side of the slide-in part 18 comprises outward conical holding protrusions 181, as illustrated in FIG. 2A. Furthermore, the holding collar 16 of the receptacle 14 has, on its inner side, an inward cone tapering away from the base ring. When the slide-in part 18 is fully inserted through the lateral opening 17 in the holding collar 16, a pre-locked position is attained, in which the ring openings overlap. The slide-in part 18 and the receptacle 14 can be brought, by mutual rotation, from the pre-locked position into the locked position in which the conical holding protrusions of the slide-in part 18 are held against the cone of the holding collar 16 and press the slide-in part against the base ring 15. At least three holding protrusions can be provided here. In a further modification of the examples, the lower side of the slide-in part 18 facing the base ring 15 or the upper side of the base ring 15 facing the slide-in part 18 has plane bearing elements 182, as illustrated in FIGS. 5A and 5B. At least two plane bearing elements 182 may be provided. According to another embodiments, the slide-in part 18 comprises magnets 60 and the receptacle 14 comprises counter magnets 62, which are arranged in a complementary manner with respect to the magnets 60 in the locked position. This can be seen, for example, in FIG. 4 and FIG. 2A. When being connected to the receptacle 14, the slide-in part 18 can thus be acted upon with a magnetic attraction force and drawn into the locked position. The holding protrusions 181 and/or the plane bearing elements 182 and/or the magnets/counter magnets 60, 62 form defined contact points which unambiguously and reproducibly define the position of the slide-in part 18 in the receptacle 14 in the locked position. The magnets 60, 62 assist the precise positioning of the slide-in part 18 and are particularly of advantage on upright microscopes. Following a collision in which the slide-in part 18 was displaced in the receptacle 14, the magnets 60, 62 pull the slide-in part 18 back into its nominal position again.

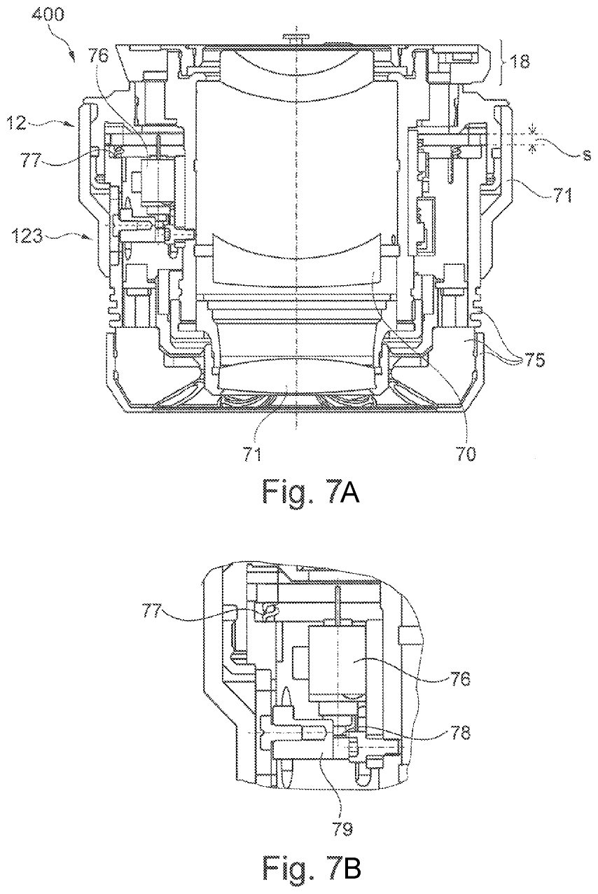

FIGS. 7A and 7B show, as a further example, a collision protecting apparatus 400 with an objective 12 in the form of an objective 123 which comprises a second collision detection device 75, 76. An objective sleeve 71 of an objective 70 of the objective 123 is mounted to the slide-in part 18, and the second collision detection device is provided in the objective sleeve 71. The second collision detection device comprises a safety element 75, which contains the objective 70, and a second displacement sensor 76. The safety element 75 is arranged resiliently and axially movably in the objective sleeve 71 by means of at least one spring element 77 acting in the direction of the front lens 71 of the objective. The second displacement sensor 76 is arranged between the front lens 71 of the objective 70 and the safety element 75. The optionally provided drive for the focusing optics of the objective 70 is not shown. For the purpose of signal generating by the second displacement sensor 76, a thrust element 79 is arranged which is adjustable in the direction of the front lens 71 of the objective and is connected to the displacement sensor at a contact point (trigger point) 78. The objective sleeve 71 can be, for example, part of a lens mount. When the objective sleeve 71 with the slide-in part 18 mounted thereto is connected to the receptacle 14 in the locked position, not only can a lateral collision of the objective device 123 be detected, i.e. from the x and/or y direction, but also a collision from the z direction, since both the first displacement sensor 30 and the second displacement sensor 76 permit active detection of a collision. With this example, a collision from all directions can therefore be detected. After eliminating the collision from the z direction, the objective 70 springs back into its former position along the spring travel S because of the spring element 77. After elimination of the collision from the x and/or y direction, the slide-in part 18 is oriented again at the optical axis, in particular if the tensioning device 30 and/or the magnets 60, 62 are provided.

In further examples, the first part 12, e.g. the objective 123 of the example above, can contain an inclination sensor as the first displacement sensor 22, for example a gyroscope, an angle-sensitive sensor evaluating a magnetic field, a strain sensor, a pressure sensor or a piezo film sensor. In the event of a lateral collision of the objective 12, the latter is inclined in relation to the receptacle 14 and the collision detected.

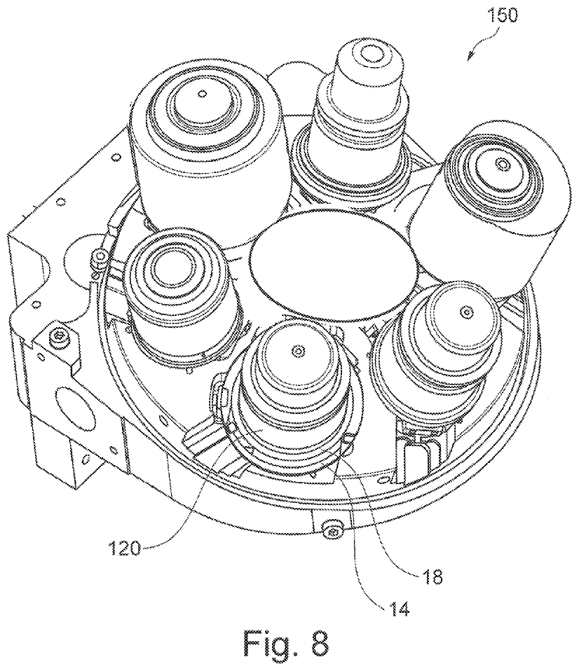

In an example which is shown in FIG. 8, the second part 13 is an objective revolver 150 of a microscope. The receptacle 14 is provided in the objective revolver 150. A plurality of receptacles 14 may also be provided. The slide-in part 18 can be inserted into the receptacle 14 and brought into the locked position.

In further examples, the collision protecting apparatus is configured to pass through data signals and/or the electrical supply power. As is illustrated in FIG. 2A, in one example the lower side of the slide-in part 18 facing the base ring 15 comprises at least one electrical contact element and the upper side of the base ring 15 oriented toward the lower side of the slide-in part 18 comprises a matching electrical mating contact element 25 in order to produce an electrical line connection and/or data connection between slide-in part 18 and receptacle 14.

In further examples, a first drive 121 is provided for moving the objective 12 in the x and/or y direction and/or a second drive 122 is provided for moving the objective in the z direction, i.e. along the optical axis of the objective, as illustrated in FIG. 3A. Furthermore, a control device 131 can be provided which is connected in a data-conducting manner via a control bus, via control lines and/or wirelessly, to at least one element selected from the receptacle, the slide-in part, the first displacement sensor, the second displacement sensor, the first drive and the second drive device. Furthermore, a storage device can be provided, for example in the control device 131.

In the disclosed embodiments of the collision protecting apparatus 10,100,200, 300, the receptacle 14 is mounted to the second part 13 and the slide-in part 18 is mounted to the objective 12; the first displacement sensor 22 of the first collision detection device 20 detects at least one displacement, selected from a movement of the slide-in part in the receptacle and a movement, in particular inclination, of the objective 13 relative to the receptacle 14. In the example of the collision protecting apparatus 400 of FIGS. 7A and 7B, in which the objective sleeve 71 of the objective 70 is mounted to the slide-in part 18 and the second collision detection device with the safety element 75 is provided in the objective sleeve 71, the movement of the safety element 75 in the objective sleeve 71 is additionally detected by the second displacement sensor 76 in the event of a collision of the objective device 123 in the z direction.

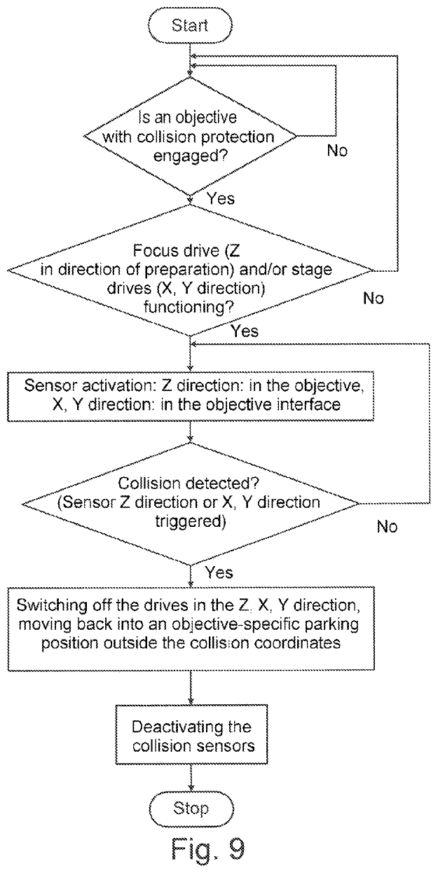

A method for operating the collision protecting apparatus is illustrated in FIG. 9 in form of a sequence diagram. The collision protecting apparatus is used here in a microscope, e.g. the receptacle 14 is mounted to a microscope stand and the slide-in part 18 is mounted to the objective 123, and they form an objective interface 11 for mounting the objective to the second part. First of all, it is determined via, for example, the position sensors 24 whether the objective 123 mounted on the objective interface 11 is provided with collision protection in accordance with the collision protecting apparatus. If this is the case, it is determined whether the drive 122 for moving the objective and/or adjusting the objective in the z direction, e.g. for the focusing optics of the objective in the z direction, i.e. in the direction of the preparation to be investigated with the microscope, and/or the drive 121 for the microscope stage operate along the x and/or y direction. If this is confirmed, the first displacement sensor 22 in the objective interface 11 and/or the second displacement sensor 76 of the objective device 123 are/is activated. If a collision is detected, the drive 121, 122 are first of all stopped and then controlled to move back the objective 123 into an objective-specific parking position outside the collision coordinates. Subsequently, the first and/or second displacement sensors are/is deactivated. These steps are initiated by the control device 131.

The controller of the collision protecting apparatus which is implemented in terms of hardware in a motorized or automated microscope system is a routine, e.g. a computer program product, in the control device 131 of the microscope. The sequence scheme illustrated in FIG. 9 shows program steps for controlling the collision protecting apparatus. When the microscope is switched on and after selection of an objective with a collision protecting function, the collision protection routine is activated and only deactivated again when an objective without a collision protecting function (e.g. objectives with relatively large working spacings) is selected. In order to avoid malfunctions or erroneous alarms during handling by the user in the area in the vicinity of the sample (e.g. when inserting the preparation), when objectives with collision protection are switched on, the displacement sensors are activated only when the objective and/or the focusing optics thereof move in the direction of the sample, i.e. in the z direction, and/or when the microscope stage moves in the x and/or y direction. When a collision is detected, various switching-off routines for the drive devices are conceivable. In addition, in the event of a collision, a signal sound can be output or a visualization can be performed in the operating software (e.g. with an indication of the specific components concerned or further handling instructions for the user).

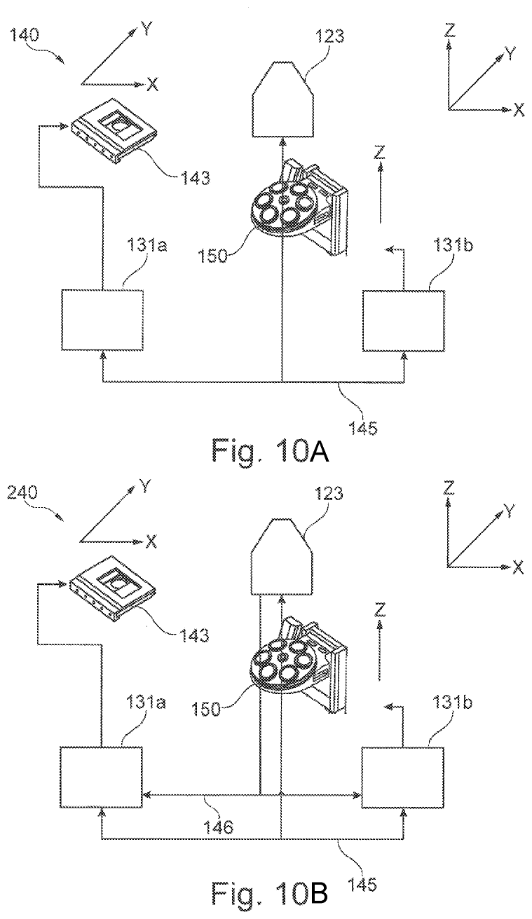

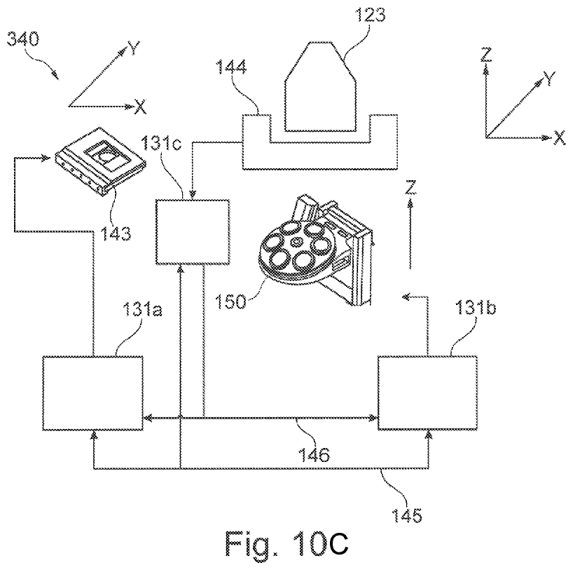

For the electrical connection of the collision protecting apparatus according to exemplary embodiments to the control device 131, there are, for example, the options shown in FIGS. 10A to 10C.

FIG. 10A shows a microscope system 140 according to an example in which the collision protecting apparatus of FIGS. 7A and 7B is implemented. Of course, the collision protecting apparatus of any other embodiment can be used equally. The microscope system 140 comprises a microscope stage 143 and the objective revolver 150. The receptacle is fastened to the objective revolver 150 and the slide-in part 18 is fastened to the objective 123. The objective interface 11 has an inclination sensor as the displacement sensor (not shown) and is connected via a control bus 145 to components of the control device 131, such as, for example, to the stage controller 131a and to the focus controller 131b. However, it is also conceivable for an inclination sensor to be accommodated in the objective 123 itself.

FIG. 10B shows an exemplary microscope system 240 with the collision protecting apparatus of FIGS. 7A and 7B according to a further example. Of course, the collision protecting apparatus of any other embodiment can be used equally. The objective interface 11 or the objective 123 has an inclination sensor as the displacement sensor 22, which is connected by means of the control bus 145 and/or by means of the direct control line 146 via direct control signals to components of the control device 131, such as, for example, to the stage controller 131a and to the focus controller 131b.

FIG. 10C shows an exemplary microscope system 340 with the collision protecting apparatus 400 FIGS. 7A and 7B according to a further example. Of course, the collision protecting interface of any other embodiment can be used equally. An objective-holding interface 144 is provided in which the displacement sensor 22, which is connected to its own evaluation electronics 131c, is provided. The evaluation electronics 131c are connected via the direct control line 146 and/or via the control bus 145 to components of the control device 131, such as, for example, to the stage controller 131a and to the focus controller 131b.

As soon as the displacement sensor 22 signals an inclination of the objective device 123, a message about a collision is sent via the control bus 145 and/or via the control line 146 of the microscope system 140 to the involved components of the control device 131, such as the stage controller 131a and the focus controller 131b. Then, the control device 131 reacts with switching-off routines: braking of the drive devices 121, 122 e.g. by counter current braking, defined stopping of the drive devices 121, 122 by shutting down; simple switching-off of the drive devices. After all of the drive devices, i.e. the drive 121 of the microscope stage and the drive 122, are at a standstill in the z direction, a travel is optionally performed in the opposite direction in order to resolve the collision issue. There are the following options for this: travel of the objective device 123 by means of the drives 121, 122 opposite to the direction from which the collision which has taken place, by precisely the absolute value of the distance which has been covered during the collision; storing the collision direction in the control device 131; storing the position from which the collision has taken place, in the control device 131. The control device 131 subsequently independently avoids a collision by a travel beyond the collision position being avoided.

1. An apparatus for mounting an objective to a microscope, a microscope stand or a microscope component, wherein the apparatus comprises:
a receptacle, which is mounted or mountable to the microscope,
a slide-in part, which is mounted or mountable to the objective and is insertable into the receptacle into a locked position in which the slide-in part and the receptacle are interlocked with play between the slide-in part and the receptacle, and
a tensioning unit, which is configured to brace the slide-in part and the receptacle against each other in order to eliminate the play, when the slide-in part is in the locked position, and
a first collision-detection device, which comprises at least one sensor configured to detect a relative displacement of at least one of the slide-in part and of the objective, the displacement being relative to the receptacle.

2. The apparatus as claimed in claim 1, wherein the sensor is configured to sense a tension state of the tensioning unit to detect the relative displacement based on a change in the tension state.

3. The apparatus as claimed in claim 1, wherein the tensioning unit comprises a thrust element and a tensioning mechanism configured to urge the thrust element against the slide-in part to brace the slide-in part and the receptacle against each other, and the sensor is configured to detect a tension state of the tensioning unit so as to detect the relative displacement based on a change of the tension state.

4. The apparatus as claimed in claim 2, wherein the tensioning unit comprises a pressure spring which is configured to press the thrust element to engage the slide-in part, and the sensor is configured to sense at least one of a displacement of the thrust element and a pressure exerted by the thrust element.

5. The apparatus as claimed in claim 3, further comprising at least one of the following features a) through d):
a) the thrust element comprises at least one of the following elements: a thrust piece, a ball, a ball bearing, a spring sheet, a lever, and a pressure sensor realizing the sensor,
b) the receptacle comprises a device positioning the slide-in part in the receptacle, wherein the tensioning unit is provided at the device,
c) the tensioning unit includes or realizes the sensor, and
d) the tensioning unit exerts pressure upon the slide-in part and upon a pressure sensor, which is arranged in or on the receptacle and is provided as the sensor.

6. The apparatus as claimed in claim 1, wherein:
the slide-in part comprises conical holding protrusions,
the receptacle comprises a base ring and a holding collar, which is provided on the base ring, and a lateral opening for receiving the slide-in part and wherein the holding collar comprises inwardly a cone tapering away from the base ring,
wherein the slide-in part is slideable through the lateral opening in the holding collar into a pre-locked position, and
the slide-in part and the receptacle are mutually rotatable from the pre-locked position into the locked position, wherein, in the locked position, the conical holding protrusions of the slide-in part engage with the cone of the holding collar and press the slide-in part against the base ring.

7. The apparatus as claimed in claim 1, wherein the sensor comprises at least one of the following elements: a position sensor, a position sensor comprising a magnetically-sensed element, a pressure sensor, a piezo film sensor, a force-measuring resistor, a gyroscope, an angle-sensitive magnetic field detecting sensor, and a strain sensor.

8. The apparatus as claimed in claim 1, wherein the sensor is configured to detect an inclination of the objective relative to the receptacle as the relative displacement.

9. The apparatus as claimed in claim 1, further comprising at least one of the following features:
an upper or bottom side of the slide-in part comprises plane bearing elements, and
the slide-in part comprises first magnets and the receptacle comprises second magnets which are arranged to be juxtaposed to the first magnets in the locked position and configured to attract the first magnets.

10. The apparatus as claimed in claim 1, wherein a tensioning force of the tensioning unit is adjustable.

11. A microscope comprising an apparatus for mounting an objective to a microscope, a microscope stand or a microscope component,
wherein the apparatus comprises:
a receptacle, which is provided at the microscope,
a slide-in part, which is provided at the objective and is movable into the receptacle into a locked position in which the slide-in part and the receptacle are interlocked with play between the slide-in part and the receptacle, and
a tensioning unit, which braces the slide-in part and the receptacle against each other in order to eliminate the play in the locked position, and
a first collision-detection device, which comprises at least one sensor detecting a relative displacement of the slide-in part and of the objective relative to the receptacle and outputting a sensor signal, and
wherein the microscope further comprises:
a drive for moving the objective mounted to the receptacle relative to a sample, and
a control device comprising a processor and being connected to the drive and to the sensor for data communication and being configured to stop or reverse the drive when the sensor signal indicates the relative displacement.

12. The microscope as claimed in claim 11, wherein the control device is configured to record a movement direction of the drive and, after the stopping, to reverse the drive counter to the previous movement direction in order to eliminate a collision state.

13. The microscope as claimed in claim 11, wherein the objective comprises a front lens, an objective sleeve and a second collision-detection device, the second collision-detection device comprising a safety element and a displacement sensor, the safety element being supported resiliently and movably at the objective sleeve by least one second spring element to allow shift of the safety element towards the front lens, wherein the displacement sensor is configured to sense shift of the safety element against the front lens.

14. The microscope as claimed in claim 13, wherein the safety element is ring-shaped and surrounds the front lens.

15. A method for operating a microscope, comprising the steps of:
using the microscope of claim 11,
moving the objective relative to a sample,
monitoring the sensor signal,
stopping movement or reversing movement of the objective once the sensor signal indicates the relative displacement.

16. The method as claimed in claim 15, further comprising the steps of:
determining at least one of the following:
a movement direction of the objective,
a movement distance of the objective still covered after the sensor signal indicated the relative displacement, and
an objective position at which the sensor signal indicated the relative displacement, and
moving the objective along a path which depends on a result of the determination.

17. The method as claimed in claim 15, further comprising:
recording a movement direction of the objective during the movement step, and
reversing the objective counter to the movement direction after the stopping step.

18. The method as claimed in claim 15, comprising at least one of the following:
the stopping step comprising stopping the objective by at least one of the following: electrical reverse current braking, ramping down, and switching off the drive,
detecting and storing a position of the objective at which the sensor signal indicated the relative displacement and excluding that position for subsequent movements of the microscope, and
defining several ranges for positions of the objective and assigning a collision probability to each of these ranges and selecting a movement speed of the objective depending on the range in which an actual position of the objective is located.

19. A computer program product having program elements which cause the microscope as claimed in claim 11 to carry out steps of the method as claimed in claim 15 when the program elements are loaded into a storage device of the microscope.

20. A tangible, non-transitory computer-readable medium, on which the computer program product as claimed in claim 19 is stored.
